(19) United States
(12) Patent Application Publication
(10) Pub. No.: US 2013/0091748 A1
(43) Pub. Date: Apr. 18, 2013

(54) Method and System for Decorating a Vehicle

(71) Applicant: David Patrick Sirmon, Fairhope, AL (US)

(72) Inventor: David Patrick Sirmon, Fairhope, AL (US)

(21) Appl. No.: 13/648,385

(22) Filed: Oct. 10, 2012

Related U.S. Application Data
(60) Provisional application No. 61/627,715, filed on Oct. 17, 2011.

(51) Int. Cl. G09F 21/04; B32B 37/12; G09F 7/18

(52) U.S. Cl. 40/591; 156/60

(57) ABSTRACT

A system for decorating a vehicle having at least two lights includes a pair of patches each having a configuration indicative of eye black worn by an athlete. Each patch includes opposed front and rear surfaces. A rear surface includes an adhering member configured to selectively adhere to the vehicle, such as beneath respective lights. The rear patch surface may include an adhesive or magnetic surface. The front patch surface may include indicia, such as the name, logo, or slogan of an educational institution or sports team. A method of decorating a vehicle includes the steps of obtaining a patch mimicking the appearance of athletic eye black and applying the patch to a vehicle.

### REFERENCE TO RELATED APPLICATIONS

This application claims the priority of U.S. provisional patent application Ser. No. 61/627,715 filed Oct. 17, 2011 titled Method and System for Decorating a Vehicle.

### BACKGROUND OF THE INVENTION

This invention relates to vehicles and, more particularly, to a method and system for decorating a vehicle.

Athletes have long applied patches of dark colors on their faces beneath their eyes so as to reduce glare that might otherwise interfere with sight during an athletic event. These patches are commonly referred to as “eye black.” Each patch of eye black is comprised of a field of dark color, such as black, configured to absorb rather than reflect light that might otherwise cause or allow glare. Indicia may be printed on eye black patches that include alphanumeric characters such as team names, team logos, religious references, taunts, or any other fan preferred indicia. Eye black patches, therefore, have become symbols of team unity, alumni identification, or even attempts at intimidation.

Another source of team spirit is found in the activity of “tailgaiting” before a sporting activity or displaying team paraphernalia from one's vehicle. For instance, a fan may choose to place bumper stickers on his vehicle exterior, hang a mascot from a rear view mirror, or even mount a flag from the bed of his pickup truck. Therefore, it would be desirable to have a method and apparatus for decorating a vehicle with patches imitating the look of an eye black patches so as to enhance one's enthusiasm for their favorite team.

### SUMMARY OF THE INVENTION

A system for decorating a vehicle having at least two lights according to the present invention includes a pair of patches each having a configuration indicative of eye black worn by an athlete. Each patch includes opposed front and rear surfaces. A rear surface includes an adhering member configured to selectively adhere to the vehicle, such as beneath respective lights. The rear patch surface may include an adhesive or magnetic surface. The front patch surface may include indicia, such as the name, logo, or slogan of an educational institution or sports team. A method of decorating a vehicle includes the steps of obtaining a patch mimicking the appearance of athletic eye black and applying the patch to a vehicle. It is understood that the “vehicle” may be a car, truck, motorcycle, golf cart, boat, or other vehicle.

Therefore, a general object of this invention is to provide a method and system for decorating a vehicle to imitate the look of an athlete wearing eye black.

Another object of this invention is to provide a method and system, as aforesaid, that includes patches resembling eye black configured to be selectively applied to a vehicle surface such as below the vehicle's headlights.

Still another object of this invention is to provide a method and system, as aforesaid, in which each patch may include a rear surface having adhesive, magnetic, or static electricity elements wherewith to be coupled to the vehicle.

Yet another object of this invention is to provide a method and system, as aforesaid, in which each patch may include a front surface having indicia including a sports team name, logo, taunt, slogan, or other words meaningful to the vehicle's driver.

A further object of this invention is to provide a method and system, as aforesaid, that is easy to use and inexpensive to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a front view of a vehicle on which patches according to a preferred embodiment of the present invention are in use;

FIG. 2 is an isolated view on an enlarged scale taken from a portion of FIG. 1;

FIG. 3 is a rear view of a vehicle on which patches according to a preferred embodiment of the present invention are in use;

FIG. 4 is an isolated view on an enlarged scale taken from a portion of FIG. 3;

FIG. 5a is a front view of a patch according to one configuration;

FIG. 5b is a front view of a patch according to another configuration;

FIG. 6a is a front view of a patch according to another configuration;

FIG. 6b is a rear view of a patch according to another configuration; and

FIG. 7 is a perspective view of the patch as in FIG. 6a.

### DESCRIPTION OF THE PREFERRED EMBODIMENT

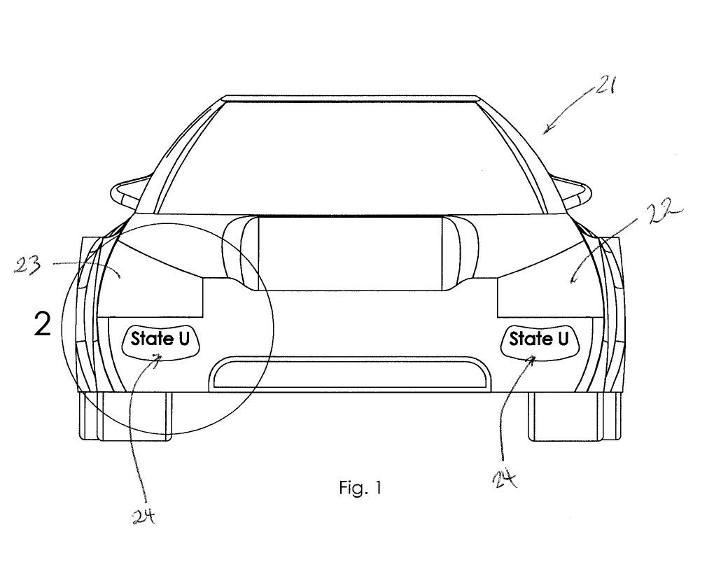

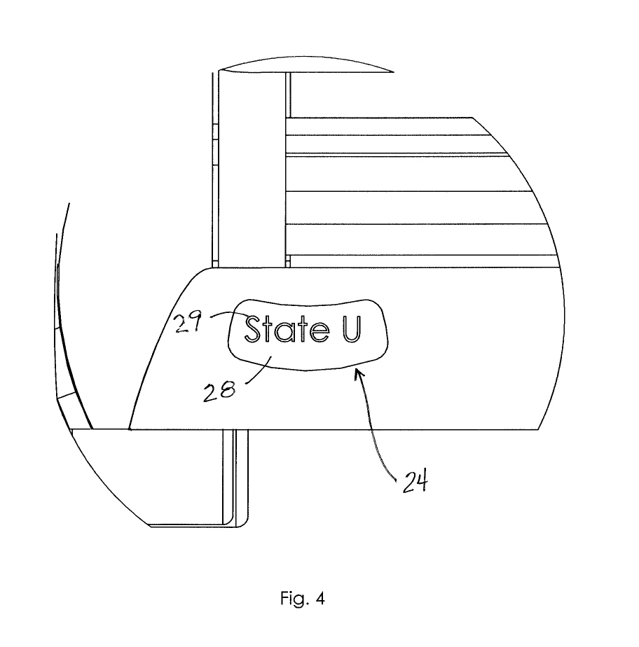

A method and apparatus for decorating a vehicle according to a preferred embodiment of the present invention will now be described with reference to FIGS. 1 to 7 of the accompanying drawings. The apparatus includes at least a pair of patches 24 for use with a vehicle 21. It is understood that the “vehicle” may be a car, truck, motorcycle, motorcycle, golf cart, or other vehicle.

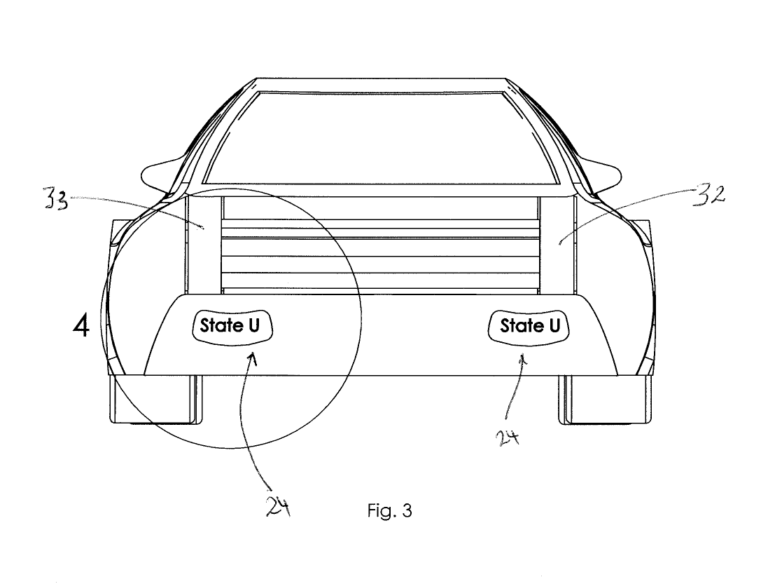

FIG. 1 illustrates the present invention in one particular context: in use on a vehicle 21. The vehicle 21 may be an automobile (e.g. a car) having a right headlight 22 and a left headlight 23. The vehicle 21 may also include a left taillight 33 and a right taillight 32. An eye black patch 24 is applied to the vehicle beneath each of the headlights, respectively. As shown in FIG. 3, a patch 24 may also be applied to the vehicle beneath each of the taillights, respectively.

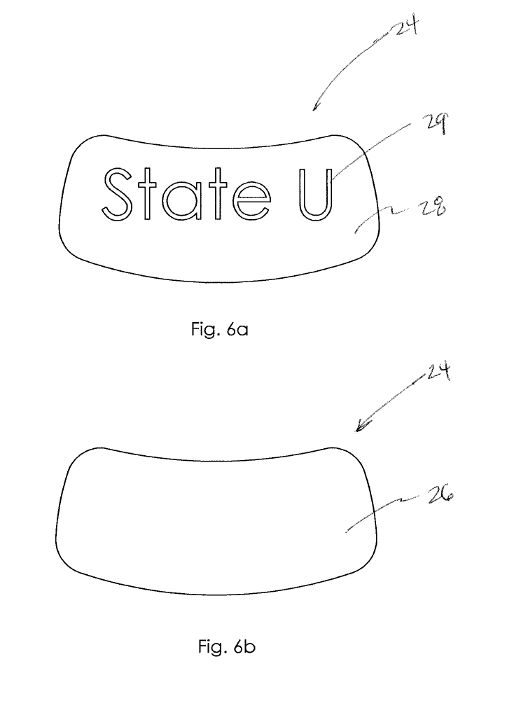

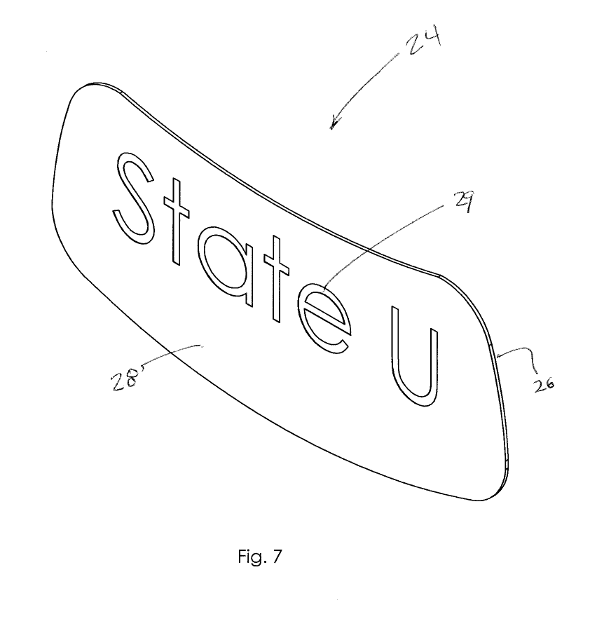

Each patch 24 includes a rear surface 26 (FIG. 6b) and an opposed front surface 28 (FIGS. 6b and 7). The front surface 28 of each patch 24 may include a field of color such as, for instance black to mimic the dark eye black of an athlete. Although a dark color is preferred, other colors may also work. Further, the front surface 28 of each patch 24 may include indicia 29 such as alphanumeric characters, graphics, logos, or other indicia that communicates a message desired by a driver. The patch 24 may be constructed of paper, plastic, a film, vinyl tape such 3M® medical tape, a laminated sheet, a painted coating or a y other material appropriate for the intended purpose.

The rear surface 26 of each patch 24 may include an adhering means that is capable of coupling the patch 24 to a surface of the vehicle. In one embodiment, the rear surface 26 of a patch 24 includes an adhesive such that the rear surface of the patch 24 may be adhesively coupled to the vehicle 21, such as beneath one or more lights (FIGS. 1 and 3). The adhesive may be a peel and stick adhesive such as that used with bumper stickers, or an easy release adhesive that permits removal of the patch when not in use. In another embodiment, the rear surface 26 of a patch 24 may include a magnet or magnetic surface such that the rear surface of the patch 24 may be magnetically coupled to the vehicle 21, such as beneath one or more lights. In still another embodiment, the rear surface 26 of a patch 24 may include a surface that causes static electricity such that the rear surface 26 of the patch 24 may be coupled to the vehicle 21 by static electrical attraction.

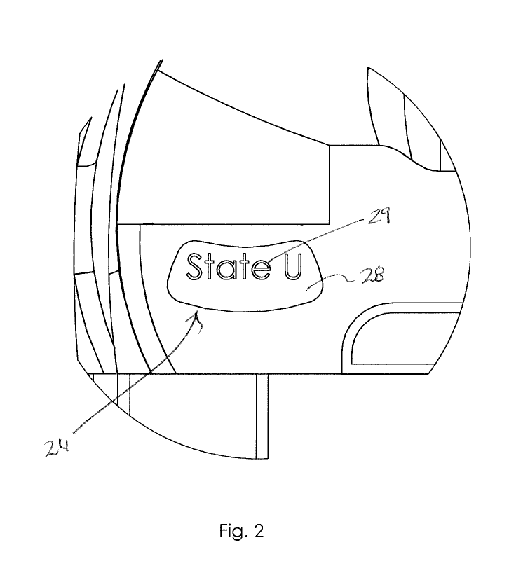

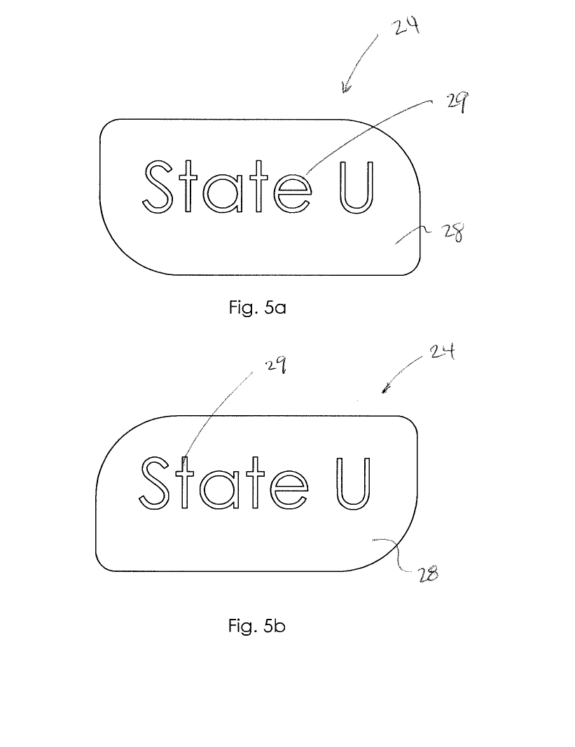

In one embodiment, each patch 24 may include a generally U-shaped configuration (FIG. 2). In another embodiment, each patch 24 may include a generally teardrop shape (FIGS. 5a and 5b). In either embodiment, a patch 24 preferably includes a relatively thin planar configuration (FIG. 7).

An exemplary method of decorating a vehicle using the apparatus described above includes obtaining one or more patches 24 and applying the patches 24 to a vehicle. More particularly, the step of applying a patch 24 to a vehicle involves securing the patch 24 thereto. This step is accomplished because each patch 24 includes an adhering structure as described above, such as an adhesive, magnetic surface, or static electricity surface. Patches 24 may be applied to a vehicle beneath respective lights, such as headlight or taillights in a manner indicative of an athlete wearing eye black.

It is understood that while certain forms of this invention have been illustrated and described, it is not limited thereto except insofar as such limitations are included in the following claims and allowable functional equivalents thereof.

What is claimed is:

1. A method for decorating a vehicle having a pair of lights, comprising the steps:
obtaining a patch simulative of eye black worn by an athlete;
applying said patch beneath at least one of the pair of vehicle lights to imitate the look of said athlete wearing eye black.

2. The method as in claim 1, further comprising:
obtaining a pair of patches, each patch being simulative of eye black worn by an athlete;
applying said pair of patches below the pair of vehicle lights, respectively, so as to imitate the look of said athlete wearing eye black.

3. The method as in claim 2, wherein the pair of lights are vehicle headlights.

4. The method as in claim 2, wherein the pair of lights are vehicle taillights.

5. The method as in claim 1, wherein the step of applying includes securing said patch to the vehicle with adhesive.

6. The method as in claim 1, wherein the step of applying includes securing said patch to the vehicle with a magnet.

7. The method as in claim 1, wherein said patch includes opposed front and rear surfaces defining a generally planar configuration, said patch including an adhesive positioned on said rear surface.

8. The method as in claim 7, wherein said step of applying includes securing said patch adhesive to a vehicle surface beneath at least one of the pair of vehicle lights.

9. The method as in claim 7, wherein said front surface of said patch includes indicia taken from the group including alphanumeric characters, a logo, a color, and artwork.

10. The method as in claim 1, wherein said patch includes opposed front and rear surfaces defining a generally planar configuration, said patch including a magnetic surface positioned on said rear surface.

11. The method as in claim 10, wherein said step of applying includes securing said patch magnetic surface to a vehicle surface beneath at least one of the pair of vehicle lights.

12. A system for decorating a vehicle having at least two lights, said system comprising:
a pair of patches having a configuration indicative of eye black worn by an athlete;
wherein each patch includes opposed front and rear surfaces, said rear surface being configured to adhere to a surface of the vehicle beneath the at least two lights, respectively.

13. The system as in claim 12, wherein each of said pair of patches includes an adhesive situated on said rear surface.

14. The system as in claim 12, wherein each of said pair of patches includes a magnet situated on said rear surface.

15. The system as in claim 12, wherein said front surface of said patch includes one of alphanumeric characters or a graphic logo.
